(19) United States
(12) Patent Application Publication
(10) Pub. No.: US 2009/0000612 A1
(43) Pub. Date: Jan. 1, 2009

(54) Apparatuses and methods for shaping reflective surfaces of optical concentrators

(76) Inventors: Braden E. Hines, Pasadena, CA (US); Michael F. Turk, Los Angeles, CA (US); Mark Brian Farrelly, Pasadena, CA (US); Richard L. Johnson, JR., Suffolk, VA (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 12/151,276

(22) Filed: May 5, 2008

Related U.S. Application Data
(60) Provisional application No. 60/927,610, filed on May 4, 2007.

(51) Int. Cl. F24J 2/10; B29D 11/00

(52) U.S. Cl. 126/683; 136/246; 126/684; 126/692; 264/1.1

(57) ABSTRACT

Apparatuses and methods for shaping reflective surfaces of optical concentrators are disclosed. An exemplary embodiment of an optical concentrator in accordance with the present invention includes a reflective surface and one or more shaping components that help to provide a desired shape to the reflective surface. Exemplary shaping components preferably comprise thin, readily manufacturable ribs with precision surfaces that provide the desired shape to a reflective surface.

### CROSS REFERENCE TO RELATED APPLICATIONS

The present application claims priority to U.S. Provisional Application No. 60/927,610 filed May 4, 2007, the entire contents of which is incorporated herein by reference for all purposes.

### TECHNICAL FIELD

The present invention is directed to optical concentrators having reflective surfaces. In particular, the present invention relates to apparatuses and methods for precisely shaping reflective surfaces of such optical concentrators.

### BACKGROUND

Optical concentrating systems, such as solar collectors, concentrate light toward a focus of the optical system. In general, there are two categories of concentrators. Line concentrators concentrate incident light in one dimension so the focus is a line. Point concentrators concentrate incident light in two dimensions so the focus is a point.

Concentrators often include one or more optical components to concentrate incident light. Some systems have a single concentrating optical component, referred to as the primary optic that concentrates rays directly onto the desired target (which may be a device such as a photovoltaic cell) after being collected and focused by the optic. More complex concentrators include both a primary optic and additional optics to provide further collection or concentration abilities or improved beam uniformity at the target.

A primary optic for an optical concentrator typically includes one or both of a refractive component and a reflective component. The most common refractive component employed includes a Fresnel lens, as in O'Neill, U.S. Pat. No. 4,069,812, the entire disclosure of which is incorporated by reference herein for all purposes. A common reflective component includes a parabolic reflector. With respect to refractive components, Fresnel lenses are usually preferred over standard lenses, because Fresnel lenses are thinner for a given aperture. As such, Fresnel lenses allow large collecting apertures without requiring as much lens material as does a standard lens. The system aperture for these concentrators is defined by the aperture of the Fresnel lens. FIG. 2 illustrates a typical Fresnel lens concentrator having optical axis 24, showing a Fresnel lens 18 bending light rays 20 towards a desired focus 16.

Large, high quality Fresnel lenses as conventionally used, however, can be prohibitively expensive for applications such as commercial rooftop systems. In addition, surface discontinuities present on Fresnel lenses sometimes make them lossy (i.e., inasmuch as some of the light that is desirably focused may instead be absorbed and/or directed away from the focus) compared to standard lenses or reflective solutions. Another disadvantage of the Fresnel concentrator as conventionally used is that it is usually not suitable by itself for certain articulating concentrators that require self-powering. Such devices require a means to generate power when the optical axis of the concentrator is not aligned with the sun thereby relying on diffuse radiation from the sky. Unfortunately, a conventional Fresnel concentrator provides negligible paths for diffuse radiation to strike a solar cell located at the focus of the lens and therefore is usually unable to generate sufficient power to articulate itself when not aligned with the sun.

Reflective primaries are known to include compound parabolic concentrators (CPCs) as per Winston, U.S. Pat. No. 4,003,638, the entire disclosure of which is incorporated by reference herein for all purposes, as well as various types of parabolic or nearly parabolic troughs and dishes. Troughs and dishes are the two main types of CPC's. Troughs and dishes may have a bottom focus wherein the optical target, for example a solar cell, is facing up. Troughs and dishes with a bottom focus advantageously collect and concentrate diffuse light even when the reflector is not directly aimed at the source(s) of the diffuse light. This makes them suitable for collecting diffuse light used for self-power. Troughs and dishes also may have an inverted focus wherein the optical target, for example a solar cell, is facing down, often suspended above the reflector.

However, because high concentration ratios tend to require a CPC with a large height/width ratio, the packing density for multiple articulating concentrators including CPC's can be limited. For example, FIG. 3 schematically illustrates a typical bottom focus CPC 28 with a geometric concentration of 10× in one dimension. Incident rays 30 are concentrated onto focal plane 26 with a normalized width of 1. The normalized height of the CPC 28 is 17.8, resulting in a height/width ratio of 1.78.

This relatively high height/width ratio factor makes conventional CPC's, by themselves, poorly suited for multiple articulating concentrator systems such as those described in U.S. Publication No. 2006/0283497, filed Jun. 15, 2006, in the names of Hines et al., titled PLANAR CONCENTRATING PHOTOVOLTAIC SOLAR PANEL WITH INDIVIDUALLY ARTICULATING CONCENTRATOR ELEMENTS and U.S. Publication No. 2007/0193620, filed Jan. 17, 2007, in the name of Hines, titled CONCENTRATING SOLAR PANEL AND RELATED SYSTEMS AND METHODS, which publications are incorporated herein by reference in their respective entireties for all purposes. Such articulating concentrator systems desirably utilize a low overall height for the optical concentrator, so that the concentrators can articulate freely.

As another drawback, parabolic troughs and dishes have aperture regions that are, in practice, often unusable for concentrating. This is typically true for troughs and dishes that have either a bottom focus or an inverted focus. Portions of the apertures of these optical elements are unusable because both the bottom and inverted focusing configurations can be affected by angle of incidence limits at the target focal plane. For example, according to Snell's law, rays striking the target at greater than a certain angle are largely reflected off the surface and are not absorbed.

FIG. 4 schematically illustrates this issue for a bottom focus reflector 34. Incident rays 36, 38, and 40 are concentrated by reflector 34 onto focal plane 32. The angle of incidence with respect to the focal plane 32 of the concentrated rays is greater for rays closer to the optical axis (not shown), which extends through the middle of the reflector 34. Rays 36 and 38 impinge on focal plane 32 at angles less than the acceptance angle of the focal plane 32 and are absorbed. Ray 40 impinges on focal plane 32 at an angle greater than the nominal acceptance angle of the focal plane and is largely reflected back out of the reflector 34 as ray 42. The same effect would be seen if ray 42 is the incident ray and ray 40 is the rejected ray. The regions 44 and 46 associated with poorly absorbed rays 44 and 42 define the portion of the aperture of reflector 34 that is not effectively usable for concentrating. In practical effect, the effective aperture of the system is reduced.

Inverted focus reflectors suffer from a similar effect except that the aperture penalty occurs near the periphery of the reflector. As schematically illustrated in FIG. 5, incident rays 52, 56, and 60 are concentrated by reflector 50 onto focal plane 48. In contrast to the situation with a bottom focus reflector, the angle of incidence with respect to the focal plane 48 of the reflector 50 increases as rays strike reflector 50 further away from the optical axis (not shown), which extends through the middle of the reflector. Rays 52 and 60 impinge on focal plane 48 at angles less than the acceptance angle of the focal plane 48 and are absorbed. Ray 56 impinges on focal plane 48 at an angle greater than the nominal acceptance angle of the focal plane 48 and is largely reflected back out of the reflector 50 as ray 58. The same effect is seen if ray 58 is the incident ray and ray 56 is the rejected ray. The regions 54 and 62 of poorly absorbed rays 56 and 58 define the portion of the aperture of the reflector that is not effectively usable for concentrating. In practical effect, this limits the width of the aperture of the reflector. In addition, as is typical of inverted focus configurations, reflector 50 suffers from self-shadowing such that rays nearest to the optical axis in region 64 are blocked by the target at the focal plane 48 itself, further reducing the light-collecting efficiency of the system.

In addition, articulating concentrator systems desirably include means to power the articulating concentrators, preferably using power generated by the device itself. Conventional optical designs can present challenges for photovoltaic devices that would like to use self-powered articulation to aim light concentrating components at the source of incident light, e.g., the sun. It is important that self-powered designs be able to capture and/or concentrate diffuse light to provide power when the light concentrating components are not aimed properly. Such devices can use bottom focus reflectors in order to provide sufficient optical paths for diffuse radiation to strike a solar cell located at the focal plane. However, as implemented conventionally, this design choice occurs at the expense of the aforementioned limitations of the bottom focus reflector. Devices that instead use inverted focus reflectors, on the other hand, generally provide only very limited optical paths for diffuse radiation to reach the target, as the target, e.g., a solar cell, is facing away from diffuse radiative sources. Also, the reflected field of view in the primary mirror tends to be very narrow. Consequently, inverted focus reflectors tend to collect little diffuse light. These conventional bottom focus and inverted focus reflectors are therefore not well-suited to self-powered systems.

A third type of concentrating primary, a reflective lens as described in Vasylyev, U.S. Pat. No. 6,971,756, the entire disclosure of which is incorporated by reference herein for all purposes, includes reflective elements in the form of concentric rings or parallel slats arranged so that incident rays are focused like a lens. These primaries can provide large concentration ratios and may overcome angle of incidence issues present with parabolic troughs and dishes. However, these generally include multiple, precision aligned surfaces that may be cost-prohibitive for some applications. Additionally, in the case of a long parallel slat form, additional support structure may be required that would tend to create undesirable optical obscurations. Further, in a manner that is analogous to the limitations of a refractive Fresnel lens discussed above, such a design has a limited ability to collect and focus diffuse light to provide for self-powering.

Some attempts have been made in the prior art to improve upon these solutions by combining multiple optical elements into a single concentrator, e.g., as described by Habraken in U.S. Pat. Pub. No. 2004/0134531 and by Cobert in U.S. Pat. Pub. No. 2005/0067008, the entire disclosures of which are incorporated by reference herein for all purposes. However, both of these approaches place the multiple optical elements in series, so that light is redirected by multiple elements before reaching the focus. The disadvantage of these approaches is that they incur the expense and optical losses of two separate, full-aperture optical elements.

Another challenge related to reflective line focus concentrators relates to the generally parabolic profile of the reflective surface. The optical performance of the reflector is affected by how well the manufactured surface matches the prescribed optical surface. Whereas precision surfaces can be easily obtained using various machining techniques used for astronomical grade optics, such methods are generally not amenable for high volume and low cost applications such as commercial rooftop photovoltaic concentrators.

Exemplary parabolic trough concentrators are described in copending U.S. patent application Ser. No. 11/654,131, to Hines et al. and assigned to the assignee of the present invention, the entire disclosure of which is incorporated by reference herein for all purposes. Such concentrators typically comprise a thin shell of reflective aluminum. Such a shell is advantageous in that it provides not only the optical surface function but also the structural encapsulation and convective cooling functions using a single element. Furthermore such a reflective shell is amenable to formation using roll bending or sheet metal presses in order to provide the basic optical profile. However, because of non-linear effects of spring back and variations in material properties it is challenging for such surface formation to produce surfaces within the required tolerances for the optical concentrator.

### SUMMARY

The present invention thus provides components and techniques for precisely shaping reflective surfaces used in optical concentrators. An exemplary embodiment of an optical concentrator in accordance with the present invention preferably includes a shell having a reflective surface and one or more shaping components that help to provide a desired shape to the shell and reflective surface. The reflective surface can comprise a surface of the shell and/or a distinct reflective element. Shaping components in accordance with the present invention preferably comprise a surface or surface portion(s) that contact the shell and/or distinct reflective element to deform, preferably eleastically, the shell and/or reflective element and provide a desired shape to a desired reflective surface. Exemplary shaping components preferably comprise thin, readily manufacturable ribs with precision surfaces that provide the desired shape to a reflective surface.

In an aspect of the present invention, an optical concentrator is provided. The optical concentrator comprises one or more reflective elements and a shaping component having a shaping surface in contact with a surface of the one or more reflective elements. Contact of the shaping component with the one or more reflective elements deforms the one or more reflective elements and at least partially defines a predetermined shape for the one or more reflective element.

In another aspect of the present invention a method of shaping a reflective surface of an optical concentrator is provided. The method comprises the steps of providing a reflective surface having a first shape, providing a shaping component having a shaping surface, and contacting a surface of the reflective surface with the shaping surface of the shaping component thereby deforming and repositioning the reflective surface to have a second shape different from the first shape.

In another aspect of the present invention a hybrid optical concentrator is provided. The optical concentrator comprises an aperture, a shell, a refractive optical element, and a plurality of shaping components. The shell comprises a reflective optical element that collects and focuses light onto a first target for a first portion of the aperture. The refractive optical element collects and focuses light onto a second target for a second portion of the aperture. The plurality of shaping components each comprise a shaping surface in contact with a surface of the reflective optical element. Contact of the shaping surfaces of the plurality of shaping components with the shell deforms the shell and at least partially defines a predetermined shape for the reflective optical element of the shell.

### BRIEF DESCRIPTION OF THE DRAWINGS

FIG. 1a is a cross sectional view of an exemplary hybrid optical concentrator in accordance with the present invention.

FIG. 1b is a perspective view of the exemplary hybrid optical concentrator of FIG. 1a.

FIG. 2 is a cross-sectional view of a prior art Fresnel lens refractive concentrator.

FIG. 3 is a cross sectional view of a prior art compound parabolic concentrator.

FIG. 4 is a cross sectional view of a prior art bottom focus parabolic reflector.

FIG. 5 is a cross sectional view of a prior art inverted focus parabolic reflector.

FIG. 6 is a cross sectional view of an exemplary faceted trough form of a hybrid optical concentrator in accordance with the present invention.

FIG. 7 is a cross sectional view showing optical pathways for diffuse light in the hybrid optical concentrator of FIG. 1a.

FIG. 8 is a perspective view of an exemplary point concentrator incorporating a hybrid optic concentrator in accordance with the present invention.

FIG. 9 is a perspective view of an exemplary optical concentrator showing in particular a plurality of shaping ribs in accordance with the present invention.

FIG. 10 is a view of an end of the exemplary optical concentrator of FIG. 9.

FIG. 11 is a cross sectional view of an exemplary shaping rib in accordance with the present invention.

FIG. 12 is a cross sectional view of an exemplary optical concentrator having a shaping rib positioned relative to an under bent reflective shell and prior to being assembled to the shell in accordance with the present invention.

FIG. 13 is a perspective view of an exemplary shaping rib including fastening tabs in accordance with the present invention.

FIG. 14 is a perspective view of an exemplary shaping rib including penetrating tabs in accordance with the present invention.

FIG. 15 is a perspective view of an exemplary optical concentrator having a parabolic reflective element and plural shaping ribs in accordance with the present invention.

FIG. 16 is a cross sectional view of another exemplary optical concentrator having a shell, distinct reflective elements, and shaping ribs in accordance with the present invention.

FIG. 17 is a cross sectional view of another exemplary optical concentrator having a shell, distinct reflective elements, and shaping ribs in accordance with the present invention.

FIG. 18 is a cross sectional view of another exemplary optical concentrator having a shell, distinct reflective elements, and shaping ribs in accordance with the present invention.

FIGS. 19 and 20 are perspective views of the exemplary optical concentrator of FIG. 18 showing openings in a shell portion of the concentrator and shaping ribs extending through the openings.

FIG. 21 is schematic view of an exemplary closure element in accordance with the present invention.

FIG. 22 is schematic view of a shaping rib have a slot for positioning a receiver in accordance with the present invention.

FIG. 23 is an articulating system having an optical concentrator in accordance with the present invention.

### DETAILED DESCRIPTION

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

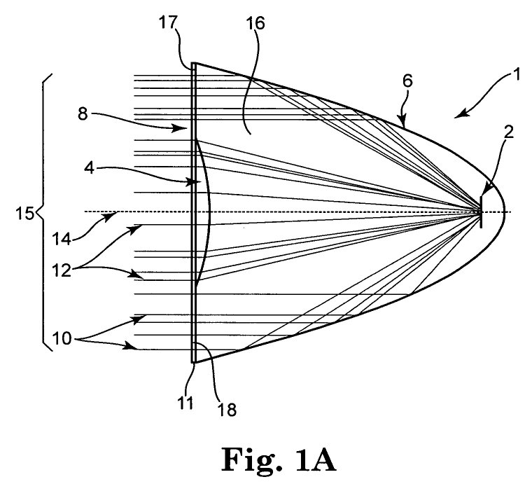

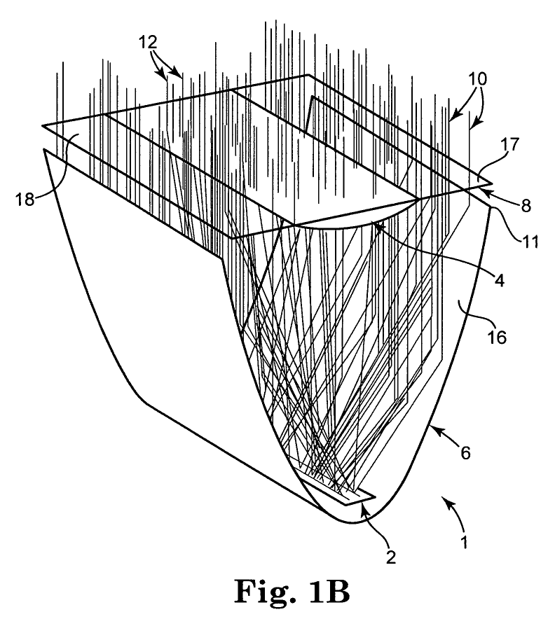

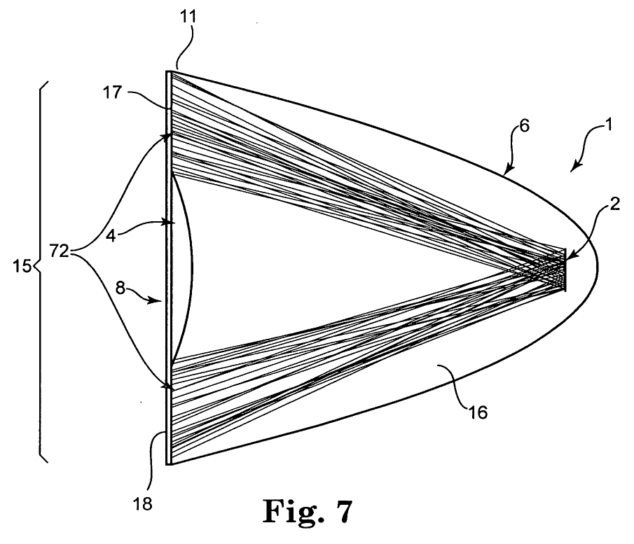

FIGS. 1a, 1b, and 7 show an exemplary embodiment of a hybrid primary optical concentrator 1 of the present invention. For purposes of illustration optical concentrator 1 is in the form of a line concentrator. The full aperture 15 of concentrator 1 spans the width (in the case of a line concentrator) or diameter (in the case of a point concentrator) of the light receiving end 11 of a reflective element in the form of a bottom focusing dish 6. The hybrid primary optical concentrator 1 includes a cover 8 fitted onto light receiving end 11. Together, the cover 8 and dish 6 provide a protective housing for device components housed in the interior 16.

The reflective surface of dish 6, as shown, is nearly parabolic in shape. However, the reflecting element, as an alternative, can use any appropriate reflecting surface including but not limited to surfaces having linear, parabolic, faceted, spherical, elliptical, or hyperbolic profiles as well as distinct reflective elements.

The cover 8 includes a refractive element in the form of integral plano-convex lens 4 in a central region of cover 8 and transparent, light transmissive outer regions 17 and 18. The lens 4 and dish 6 share a common focal plane 2 and a common optical axis 14. Lens 4 is positioned so that lens 4 is centered about the optical axis 14 of the concentrator 1. The nearly parabolic reflector dish 6, as shown, is centered about the optical axis 14 of the system.

Lens 4 may be of any suitable type including Fresnel and standard types. Even though Fresnel lenses tend to be expensive and lossy, Fresnel lenses are commonly used because a standard lens of the required diameter would typically be too thick and would typically use too much expensive and/or heavy optical material. In contrast, a refractive element of the present invention provides concentration for only a fraction of the system aperture 15, thereby allowing a smaller-diameter and thus much thinner lens for the same concentration ratio, as compared to a much thicker, full-aperture lens. As such, the present invention may alternatively employ a standard lens for a range of system apertures that would traditionally require a Fresnel lens. For purposes of illustration, lens 4 is shown as a standard lens.

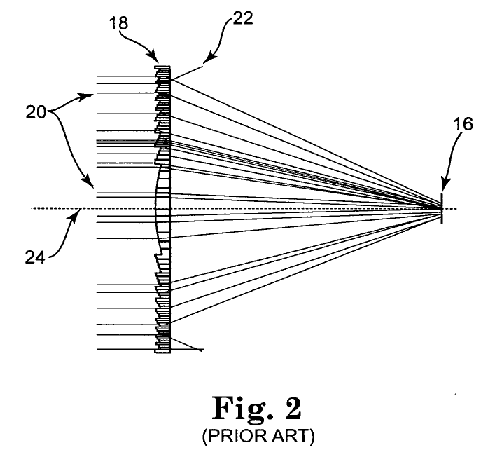

A comparison between FIG. 1 and FIG. 2 illustrates this advantage given concentrators with, for instance, a 10× geometric concentration in one dimension. Both primary optics (that is, the Fresnel lens primary optic 18 of FIG. 2 and the hybrid primary optical concentrator 1 of FIG. 1 including lens 4 and reflecting dish 6 with normalized apertures often (10) units concentrate incident rays 10 and 20, respectively, onto focal planes 2 and 16, respectively, each having a normalized width of one (1) unit. The standard lens element 4 of the hybrid optics of FIG. 1 concentrates a fraction of the total aperture 15 in contrast to the Fresnel lens 18 of FIG. 2, which concentrates the entire aperture. In the hybrid optical concentrator 1 of FIG. 1, the portion of the aperture not concentrated by lens 4 is concentrated by reflecting dish 6. Consequently, the embodiments of the present invention that use a standard, yet thin, standard lens 4 to concentrate only a portion of the aperture 15 may reduce the system cost. In this regard, compare the large thick, full aperture, standard lens of Cobert, US Patent Publication No. 2005/0067008, the entire disclosure of which is incorporated by reference herein for all purposes, to the much smaller and thinner lens 4 of FIG. 1. The hybrid optics approach of FIG. 1 also may improve optical throughput by eliminating the loss associated with discontinuities present with a full aperture Fresnel lens. Such losses are illustrated by the improperly refracted ray 22 shown in FIG. 2.

Advantageously, each optical element of the hybrid primary optical concentrator 1, i.e., lens 4 and dish 6 in this embodiment, serves as the primary optic for its respective portion of the collecting aperture 15. This differentiates concentrator 1 from and improves upon multi-stage concentrators that incorporate refractive and reflective components only in series.

For example, in use, incident rays 12 that are incident upon the central portion of the collecting aperture 15 pass through lens 4 of cover 8 and are thereby refractively focused by lens 4 onto the common focal plane 2. In the meantime, incident rays 10 that are incident upon the outer portions 17 and 18 of the collecting aperture 15 pass through cover 8 and are focused by the reflecting dish 6 onto the common focal plane 2. In other words, incident rays 12 are concentrated by lens 4 and not by the dish 6, while incident rays 10 are concentrated by the dish 6 and not by the lens 4.

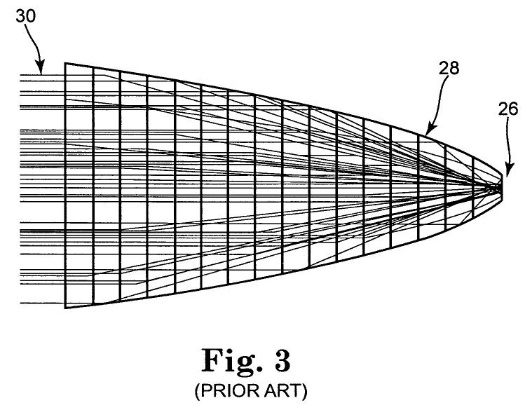

The hybrid approach of the present invention provides numerous advantages. First, CPC reflector concentrators in which only a reflector is provided to serve a full aperture, as shown in FIG. 3, tend to be too tall to be well suited to applications in which the concentrators must articulate within close proximity of one another. In contrast, as illustrated in FIG. 1, the present invention enables concentrator designs that have comparable concentrating power to a CPC design at lower height/width ratios, e.g., a height/width ratio of one (1), making the hybrid approach well suited to applications in which an array of concentrators must articulate within close proximity of one another.

As another advantage, the present invention requires no additional obscuring support structure. In contrast, the reflective lens of Vasylyev, U.S. Pat. No. 6,971,756, the entire disclosure of which is incorporated by reference herein for all purposes, requires multiple precision aligned surfaces and support structures.

Hybrid optics in accordance with the present invention also are compatible for use with self-powered, articulating optical concentrators, because the present invention provides sufficient paths for diffuse radiation to reach the focus plane 2. This is best seen in FIG. 7. Because the total aperture 15 of the hybrid optical concentrator of the present invention is larger than the lens aperture, there exist optical paths not parallel to the optical axis 14, through the cover element 8, that strike neither the refractive element 4 nor the reflective dish 6. These optical paths allow diffuse radiation 72 to be directly absorbed by a solar cell located at the focal plane 2. This helps an articulating optical concentrator that includes the hybrid optical concentrator to generate sufficient self-power to articulate itself even when not pointed at the sun. In contrast, inasmuch as full aperture Fresnel refractors typically allow only a small amount of diffuse light to reach the focal plane, full aperture Fresnel-refractor systems are generally not well suited to self-powering.

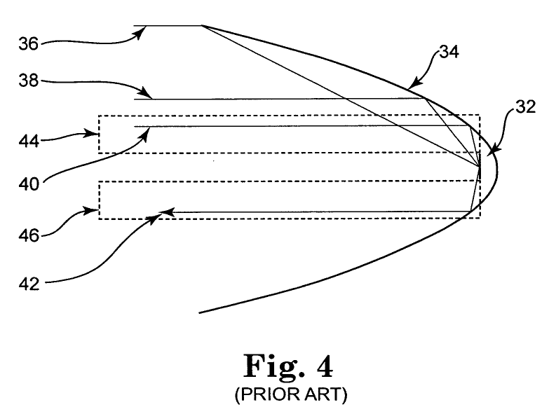

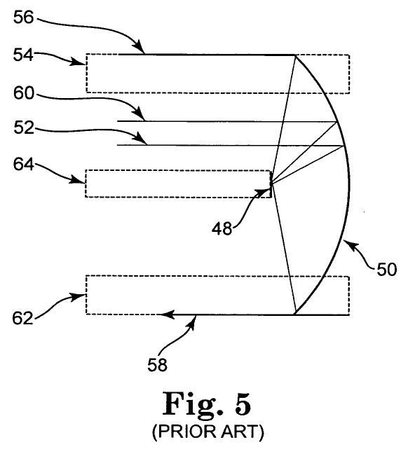

The use of hybrid optics in accordance with the present invention also avoids a key drawback conventionally associated with full aperture reflective components. If a reflective element is used by itself to serve a full aperture, as explained above with respect to FIGS. 3 and 4, the aperture would include regions associated with non-absorbed rays. These regions correspond to portions of the aperture that are not available for concentrating in a conventional system. Specifically, conventional bottom focus and inverted focus reflectors serving the full aperture tend to have a poor acceptance angle for incident light in certain regions of the aperture and, as a consequence, tend to be poorly suited to self-powering applications.

In contrast, the present invention overcomes the above limitations of both bottom and inverted focus reflectors by using refractive concentrating for the portions of the system aperture where the reflector is not suitable. Thus, the lens 4 of the hybrid optical concentrator 1 of the present invention is positioned in those regions of aperture 15 to collect and concentrate corresponding incident light that otherwise would be unused. The full aperture 15 not only is used for collecting and focusing (a feat which is not accomplished with a full aperture reflective element used by itself), but also the optics can further capture diffuse light for self-powering (a feat which is not accomplished with a full aperture refractive element such as a lens). The ability to capture and concentrate light using the full aperture also helps self-powering performance. In practical effect, the hybrid approach provides the benefits of both a reflector and a refractor without the major drawbacks of either.

In one preferred embodiment, the cover 8 and lens 4 are 5 inches wide and may be constructed of acrylic or methacrylic, and the trough is 5 inches wide and 5 inches deep and may be constructed of high-reflectivity, aluminum sheet metal manufactured by Alanod under the trade name MIRO (distributed by Andrew Sabel, Inc., Ketchum, Id.). In the preferred embodiment of optical concentrator 1 shown in FIGS. 1a, 1b, and 7, the hybrid optical concentrator forms the primary optic for the concentrator system, and light redirected by the hybrid optical concentrator 1 directly strikes the target surface at focal plane 2. In alternative forms of this invention, the light redirected by this primary optic optionally may be further redirected by additional optics, or may be redirected by one or more pre-primary optics prior to reaching this primary optic. For example, alternative embodiments may include additional optical elements (not shown) intended to help steer diffuse radiation 72 through the clear regions of the cover 8. As another option, reflectors could be added outside of the enclosed space of the concentrator module to help direct additional diffuse radiation through the clear regions of the cover 8 to the focal plane 2.

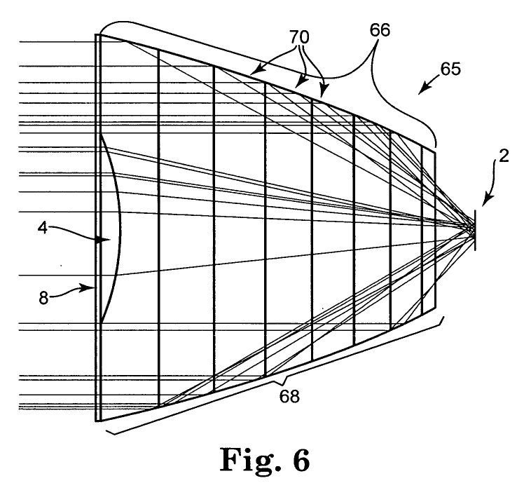

In another alternate form of this invention, the individual reflective or the refractive elements of the hybrid optical concentrator may be replaced by multiple distinct individual elements, each focusing its own portion of the input aperture, by way of example, using a faceted refractive lens with a parabolic or faceted-parabolic reflector. For instance, another alternate form of an optical concentrator 65 of the present invention uses two faceted but monolithic reflectors 66 and 68 illustrated in FIG. 6. Each reflector 66, 68 includes a plurality of facets 70, each having a continuous profile that may include but is not limited to linear, spherical, parabolic, elliptical, and hyperbolic profiles. Faceted reflectors are advantageous in that they are non-imaging and may be designed to concentrate light more evenly across the focal plane 2. As the reflective element is composed of two disjoint reflectors this also helps to eliminate reflector material in the portion of the concentrator aperture that is concentrated by the refractive element 4, possibly reducing cost.

In accordance with a preferred mode of practice, the facet coordinates can be determined by a methodology that uses the following parameters:
Y_{cell}—Half width of the target cell or focal plane
φ—Acceptance half angle (radians). This is the angle relative to the optical axis in which incident rays are still concentrated onto the target surface.
Yₘₐₓ—Half width of the reflector
Zₘₐₓ—Reflector height relative to the target surface.

The solution for each facet coordinate is an iterative process that begins with the outermost coordinate defined by (Yₘₐₓ, Zₘₐₓ). The first step is to compute the facet slope so an incident ray impinging on the top of the facet at an angle of +φ from the optical axis results in a reflected ray that impinges the cell at a position −Y_{cell}. The second step is to solve for the (y,z) coordinate of the facet bottom using the facet slope previously computed so an incident ray impinging at the facet bottom at the angle −φ from the optical axis results in a reflected ray that impinges the cell at a position +Y_{cell}. These two steps are then repeated for each facet using the bottom (y,z) coordinate of the previous facet as the top coordinate of the next facet. The equations for these two steps are as follows:

$${m}_{i} = tan ( \frac{π - arctan ( \frac{{y}_{i} - {y}_{i}^{=}}{{z}_{i}} ) + φ}{2} ) \qquad 1 )$$

Where: yᵢ⁻=−Y_{cell} and mᵢ is the slope of the facet whose top coordinate is (yᵢ,zᵢ).

$${y}_{i} = \frac{{y}_{i}^{+} + ( {z}_{i - 1} - {m}_{i - 1} ) tan ( π - 2 arctan ( {m}_{i - 1} ) - φ )}{1 - {m}_{i - 1} tan ( π - 2 arctan ( {m}_{i - 1} ) - φ )} \qquad 2 )$$

Where: Yᵢ⁺=Y_{cell}

The following coordinates for a representative, faceted reflector can therefore be determined given:
Y_{cell}=0.25”
φ=2.1 degrees
(y₀, z₀)=(2.5”, 5”)

| Facet # | y (in) | z (in) | m |
|---|---|---|---|
| 1 | 2.5 | 5 | 4.212103 |
| 2 | 2.45662 | 4.817277 | 4.128815 |
| 3 | 2.400028 | 4.583623 | 4.020582 |
| 4 | 2.326947 | 4.289793 | 3.881534 |
| 5 | 2.233829 | 3.92835 | 3.705591 |
| 6 | 2.117269 | 3.496428 | 3.487403 |
| 7 | 1.974757 | 2.999432 | 3.223974 |
| 8 | 1.80587 | 2.454945 | 2.917091 |
| 9 | 1.613921 | 1.895013 | 2.576414 |
| 10 | 1.407809 | 1.363981 | 2.222312 |
| 11 | 1.20313 | 0.909121 | 1.885937 |

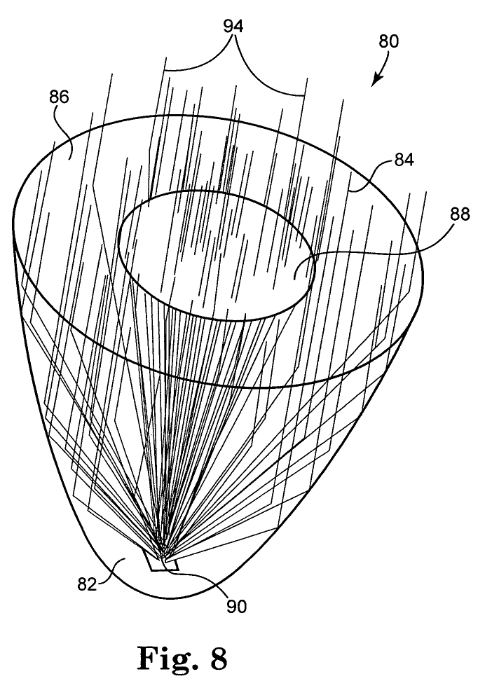

FIG. 8 shows another embodiment of a hybrid optical concentrator 80 of the present invention that is in the form of a point concentrator. Concentrator 80 includes a generally parabolic reflector dish 82 having light receiving end 84. Light transmissive cover 86 is fitted over light receiving end 84 and includes a light refractive element in a central region in the form of lens 88. Lens 88 is preferably integral with cover 86. The dish 82 and lens 88 share a common focal point 90. In use, incident light rays 92 that impinge upon lens 88 are refracted and concentrated onto focal point 90. In the meantime, incident light rays 94 pass through cover 86 and are then reflectively concentrated by dish 82 onto the common focal point 90. Thus, dish 82 and lens 88 serve different portions of the full aperture of hybrid optical concentrator 80.

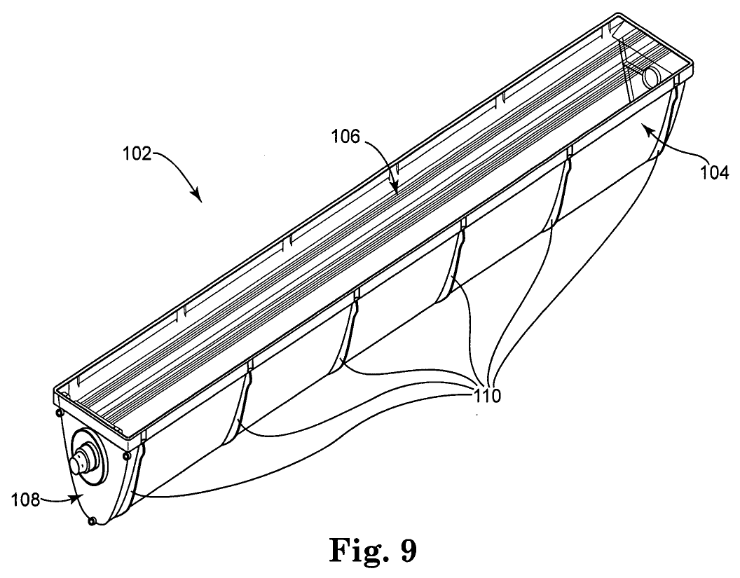

FIG. 9 illustrates an exemplary concentrating trough 102 in accordance with the present invention and similar to those described above. Trough 102, as shown, comprises a reflective shell 104 (preferably aluminum), transparent lens/cover 106, end caps 108, and shaping ribs 110. Additional functional components are contemplated and described herein. In accordance with the present invention, ribs 110 function to help conform shell 104 to a desired surface prescription by applying force (preferably compressive or squeezing) against the shell 104. That is, the reflective shell 104 is manufactured so it is slightly under-bent. There is a natural outward force (a preload) from the spring of the shell material thereby keeping it in contact with the ribs 110. The number and spacing of ribs 110 is selected to achieve the desired shape of the reflective surface of the shell 104.

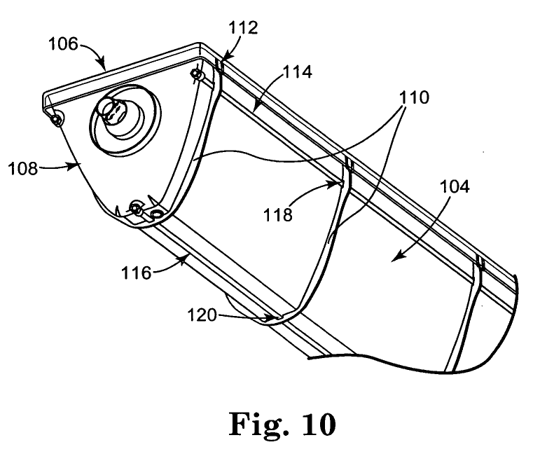

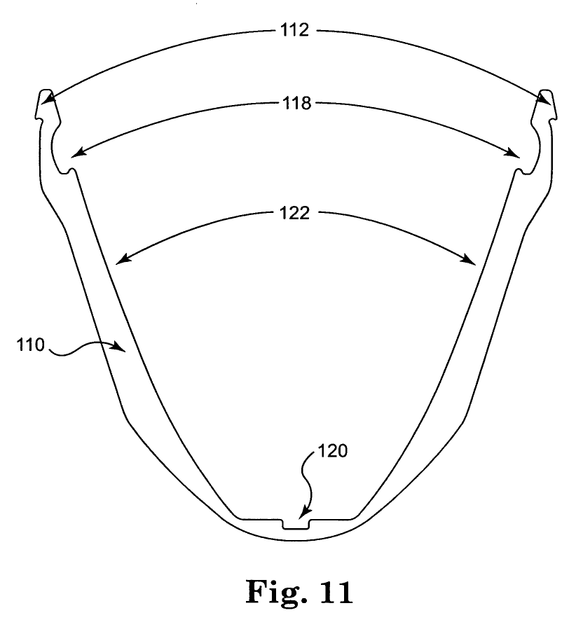

Referring to FIGS. 10 and 11, ribs 110 preferably provide fastening mechanisms 112 for constraining lens/cover 106. It is noted that fastening mechanisms 112 are optional and not required in rib structures in accordance with the present invention. The fastening mechanisms 112 advantageously prevent the lens/cover 106 from applying undesirable deformation forces on the reflective shell 104. Additionally, ribs 110, as shown, include optional features 118 and 120 by which tie rod elements 114 and 116 are used to register the spacing of ribs along the length of the trough 102. Tie rod elements 114 and 116 also function to hold end caps 108 in place.

FIG. 11 shows the cross section of an exemplary rib 110 in accordance with the present invention. Rib 110 includes surface 122 which functions to conform the reflective shell 104 to the required optical shape (prescription). Because the rib 110 lies completely in one plane, it may be easily stamped out of appropriately thick sheet metal stock with high accuracy. The accuracy of the stamped contours exceeds the accuracy obtainable by the formed reflective shell. Other manufacturing techniques are contemplated including wire EDM, laser cutting, water jet cutting, and the like. Preferred techniques are those where high precision, repeatability, and efficiency are provided.

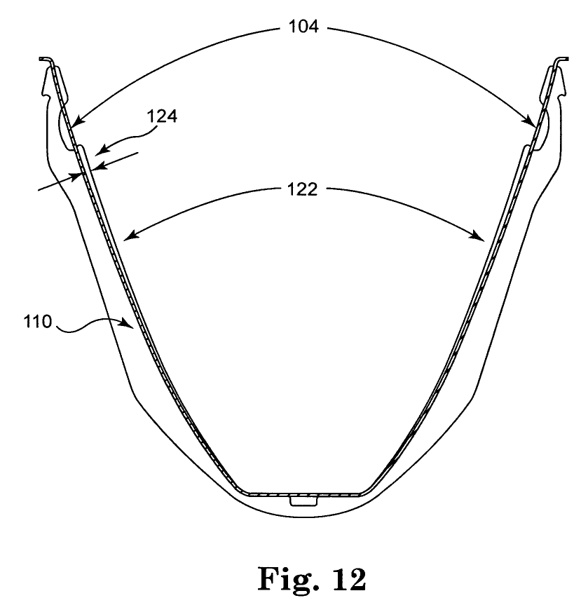

FIG. 12 illustrates the reflective shell 104 in a position relative to the rib 110 before the rib 110 is assembled to the shell 104 to conform the shell to surface 122 of rib 110. As shown, the under-bending of the reflective shell 104 provides an offset 124 between the shell and the rib surfaces 122. This under-bending enables rib surfaces 122 to force the shell 104 to conform to the desired optical shape. Portions of the shell 104 between adjacent ribs 110 are not directly in contact with the rib surfaces 122 and may exhibit small deviations from the desired contour depending on the longitudinal rigidity of the reflective shell material. It is such considerations that ultimately determine the number and spacing of ribs required by the trough design.

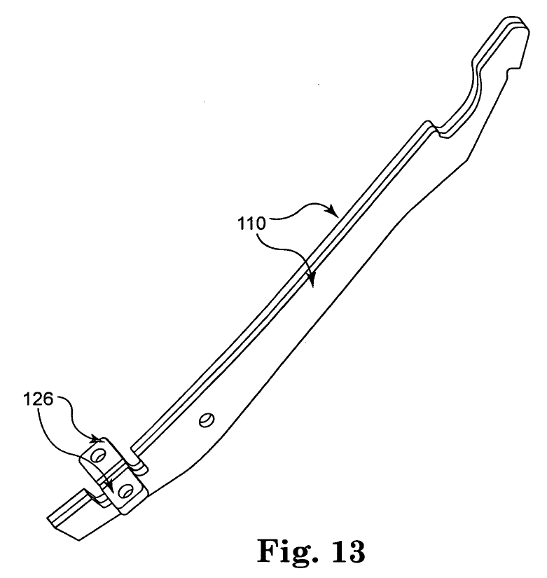

In FIG. 13 rib 110 is illustrated with optional tabs 126. These tabs 126 provide a mechanism by which to attach the shell 104 to the rib 110. Contemplated fastening methods include but are not limited to fasteners such as rivets, screws, bolts, and the like as well as joining techniques such as spot welds and adhesives and the like. Preferably, tabs 126 and associated fasteners/joints are located along portions of the shell 104 that are not used optically and therefore potential slight deformations around the fastening/joining region do not affect the concentrator performance. Preferably, as shown, tabbed ribs are arranged back to back so as to form a composite rib having symmetric tabs. Composite rib halves may be bonded together using applicable methods. Such arrangement advantageously balances twisting forces that may be introduced by fasteners pulling both rib tab 126 and shell 104 together. In addition, the tab features 126 do not require the rib apparatus 110 to envelope the trough allowing the ribs to have less total area. From a manufacturing standpoint, these non-enveloping ribs allow more ribs to be stamped per unit area of material because the shape is amenable to a less wasteful tiling schema.

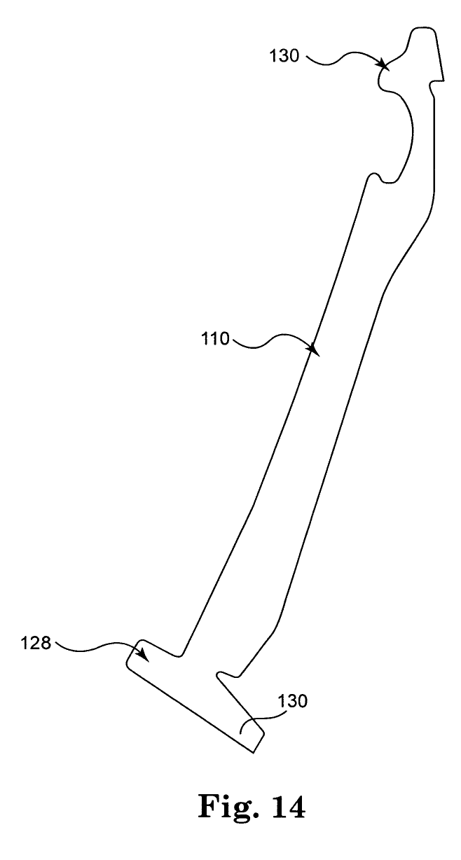

FIG. 14 illustrates rib 110 with the addition of optional exemplary penetrating tab features 128 and 130 that enable the rib 110 to apply compressive force on the reflective shell thereby forcing the shell toward the rib surface 122. Such an embodiment therefore does not solely rely on the spring back force resulting from an under bent shell. As with the previously described embodiments, the penetrating tab embodiments do not require the rib apparatus 110 to envelope the trough and has similar manufacturing advantages.

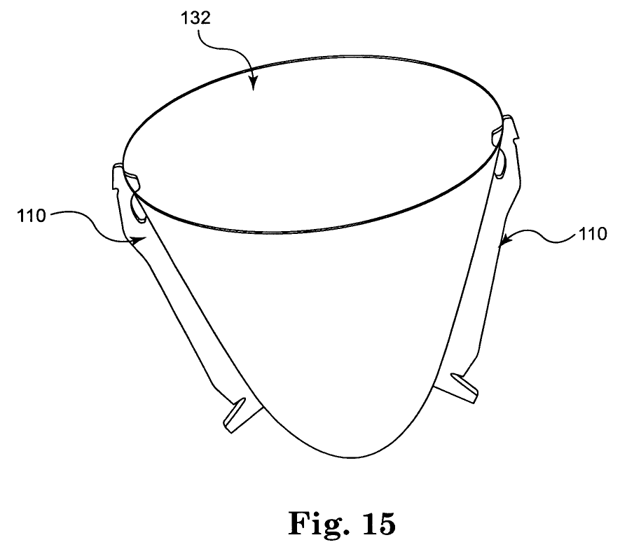

In FIG. 15 another exemplary optical concentrator 132 in accordance with the present invention is illustrated. Concentrator 132 comprises concentrating element 134 and shaping ribs 110. Concentrating element 134, as shown, comprises a parabolic reflector dish such as the parabolic reflector dish 82 shown in FIG. 8. Any optical component that functions to redirect incoming light for use as an optical concentrator can be used for concentrating element 134. Shaping ribs 110 are also exemplary and any shaping rib and/or device that functions to shape concentrating element 134 by contact with at least a portion of concentrating element 134 and elastic deformation of concentrating element 134 can be used. Any number and type of shaping ribs 110 can be used to provide a desired shaping function.

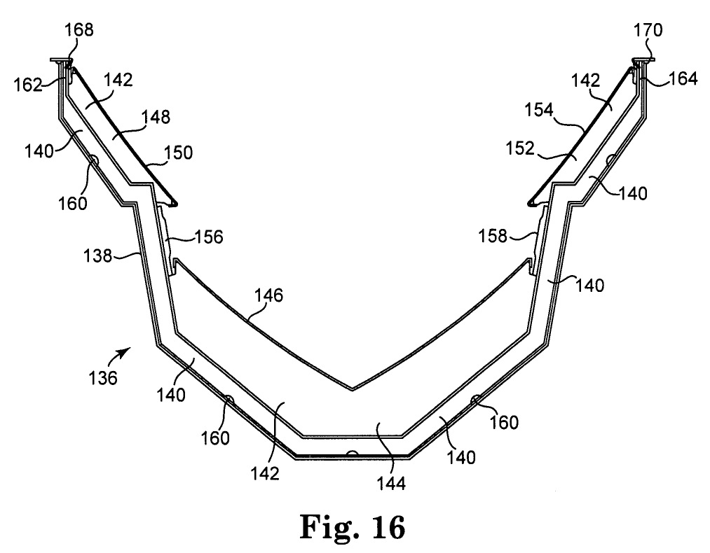

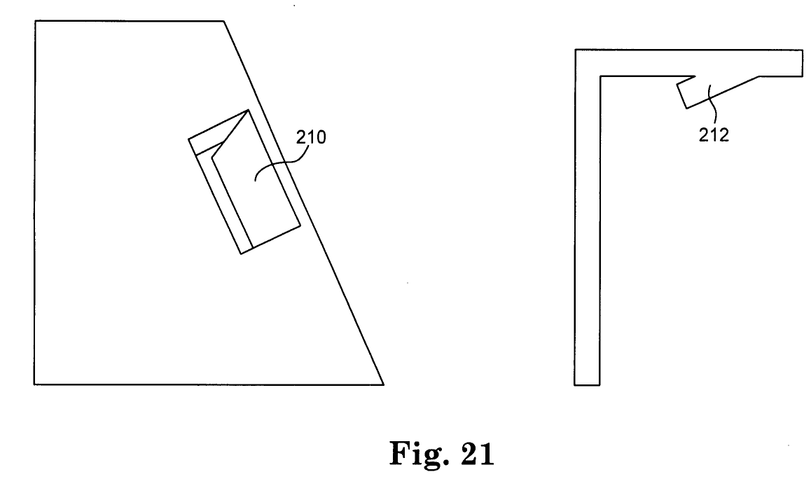

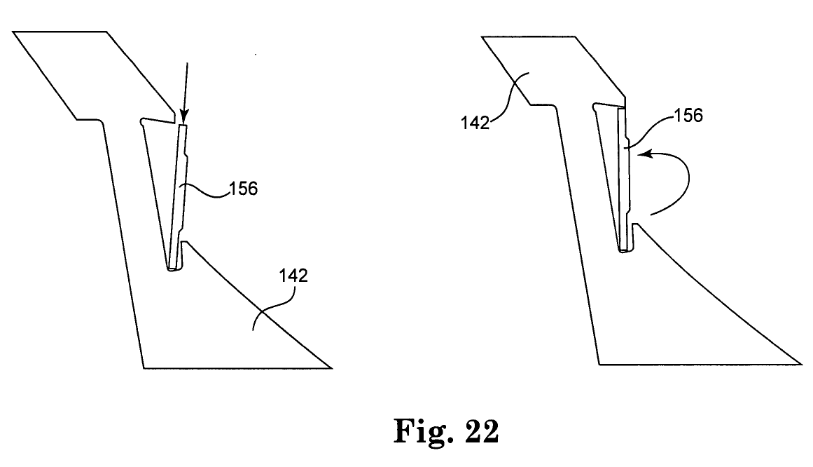

FIG. 16 shows another exemplary optical concentrator 136 in accordance with the present invention. Concentrator 136 comprises trough 138, which includes plural spaced apart embossed regions 140. Embossed regions function to provide channels in the interior of trough 138 that are used for positioning spaced apart shaping ribs 142. Shaping ribs 142 comprise a first portion 144 that supports first reflective element 146, second portion 148 that supports second reflective element 150, and third portion 152 that supports third reflective element 154. Concentrator 136 also includes first receiver 156 positioned between first reflective element 146 and second reflective element 150 and second receiver 158 positioned between first reflective element 146 and third reflective element 154 and supported, at least partially, by shaping ribs 142. Receiver 156 is positioned in a slot portion 166 of shaping ribs 142 as can be seen in FIG. 22 and extends along a length of trough 138. Receiver 158 is preferably positioned in a similar slot portion (not shown) of shaping ribs 142. Receivers 156 and 158 may comprise an array of solar cells, wired in series, and provided on an aluminum substrate, for example. Concentrator 136 also includes closure elements 168 and 170 and may comprise any desired structure suitable for attaching a lid and/or lens or the like. For example, FIG. 21 illustrates an exemplary receiver 210 and catch 212 that can be used as closure elements 168 and 170. An exemplary process that can be used to assembly optical concentrator 136 is described below.

Embossed regions 140 function to provide channels in which shaping ribs 142 are positioned. Preferably, the width of the channels is larger than the thickness of a shaping rib. The embossed regions 140 of trough 138 thus preferably include plural embossed button regions 160 that extend into the channel defined by adjacent embossed regions. The buttons regions preferably contact the shaping ribs and help to hold the shaping ribs in place.

In the exemplary optical concentrator 136 shown in FIG. 16 the embossed regions 140 have a reduced and/or reducing depth at regions 162 and 164 near the top of the trough 138. Preferably, in regions 162 and 164, the depth of the emboss decreases so that the emboss stops before it gets to the top of trough 138. The reason for this is that if the emboss extended to the top, it could increase the effective width of trough 138, requiring more space between an array of plural troughs than desired.

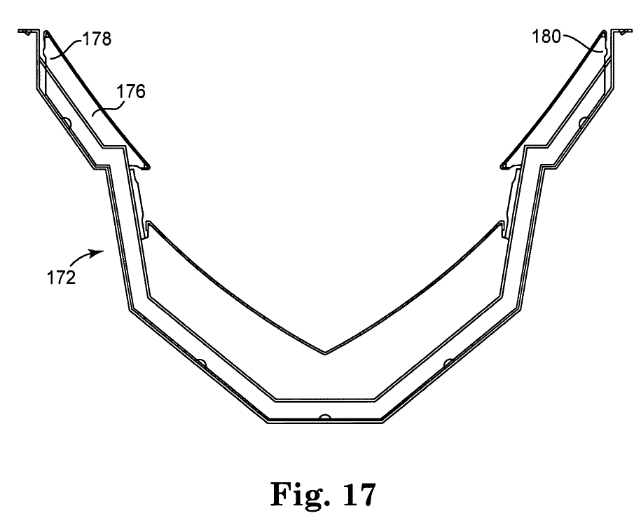

In FIG. 17 another exemplary optical concentrator 172 in accordance with the present invention is shown. Concentrator 172 is similar to concentrator 136 shown in FIG. 16. Concentrator 172 includes embossed regions 174 that do not extend to the top of the trough. Shaping ribs 176 are preferably relieved at end portions 178 and 180 of shaping ribs 176 and preferably allow a gap between the shaping rib and the trough wall.

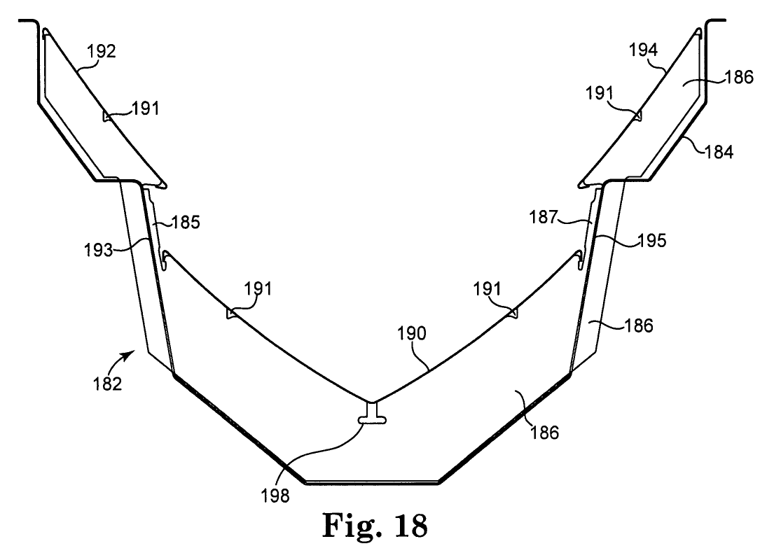

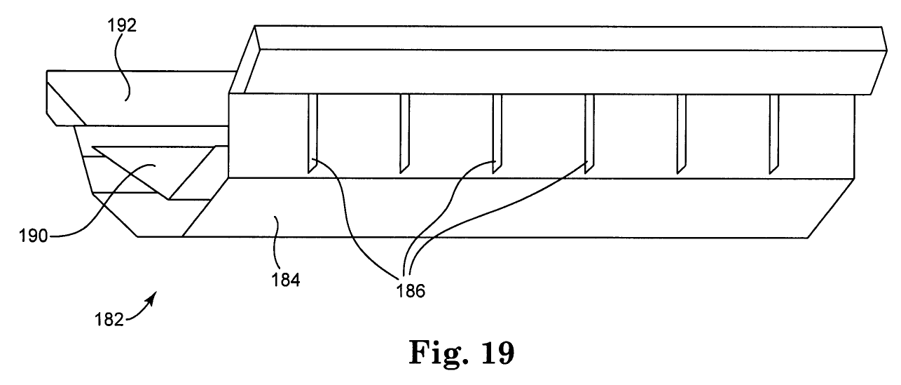

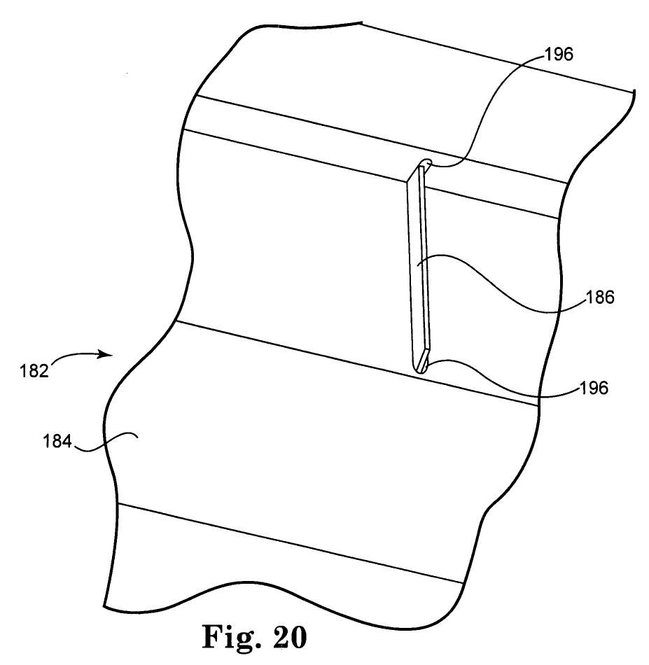

FIGS. 18, 19, and 20 show another exemplary optical concentrator 182 in accordance with the present invention. Concentrator 182 includes trough 184, shaping ribs 186, receivers 185 and 187, and reflective elements 190, 192, and 194. Trough 184 utilizes plural spaced apart slots 196 that function to position and help hold shaping ribs 186 in place. In an exemplary embodiment, shaping ribs 186 preferably fit to trough 184 by an interference fit between ribs 186 and slots 196 of trough 184. For example, a swaging process may be used to provide a desired interference and/or friction fit between ribs 186 and slots 196 of trough 184. Slots 196 may be used instead of and/or in place of the embossed structure described with respect to FIGS. 16 and 17.

Shaping ribs 186 also may include slot 198 which can include clip (not shown) to help hold reflective element 190 to shaping rib 186. For example, a clip with bar structure at the top portion and a hook structure at the bottom portion of the clip can be used. The top bar of the clip can protrude through a small hole in reflective element 190 and can run longitudinally along the fold at the base of reflective element 190.

Optical concentrators, such as those described herein, can be assembled by preparing an endoskeleton assembly including one or more shaping ribs and receivers and subsequently assembling the endoskeleton to a shell. Referring to optical concentrator 182 an exemplary assembly process includes assembling receivers 185 and 187 to shaping ribs 186 (with or without reflective elements 190, 192, and 194) to provide an endoskeleton assembly. In this assembly process a fixture (not shown) can be used to position shaping ribs 186 and receivers 185 and 187 relative to each other and relative to the fixture by using portions of the fixture that mate with grooves 192 provided in shaping ribs 186. Any desired structure, connector, and/or clamp or the like can be used to position components of optical concentrator 182 relative to each other during assembly. The shaping ribs 186 are then attached to a first portion of receivers 185 and 187. After the shaping ribs 186 are attached to receivers 185 and 187, shell 184 is positioned over the shaping rib/receiver assembly (or the shaping rib/receiver assembly is positioned within the shell). Shell 184 is then squeezed or otherwise moved (if needed) so an inside surface of shell 184 contact a second portion of receivers 185 and 187 at interface 193 and 195 respectively. Reflective elements 190, 192, and/or 194 are then preferably positioned on shaping ribs 186 but may be positioned on shaping ribs 186 before or after assembly of the shaping ribs 186 and receivers 185 and 187.

Any desired assembly process, however, can be used for assembling optical concentrators in accordance with the present invention. Preferably, such assembly comprises causing contact between the receivers, shaping ribs, and external shell. That is, as described above, a first portion of a receiver is attached to a shaping rib and the external shell is caused to contact a second portion of the receiver. Providing such contact between a receiver and a shaping rib functions to provide structural stability and provides a thermal path to help provide a cooling function to the receiver.

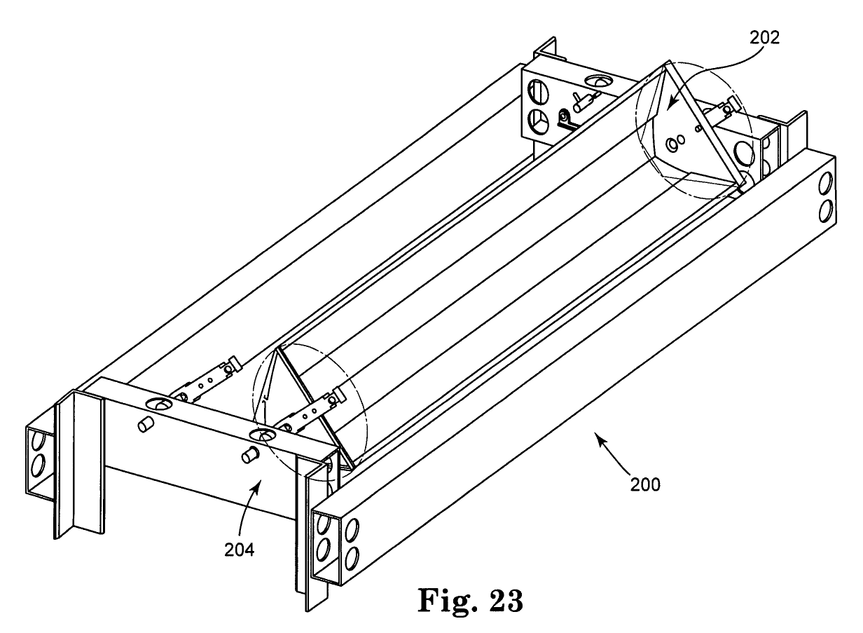

FIG. 23 shows an optical concentrator assembly 200 in accordance with the present invention. Assembly 200, as illustrated, includes optical concentrator 202 and articulating device 204. Optical concentrator 202 may comprise any of the optical concentrators described herein. Optical concentrator assembly 200 may include any desired number of optical concentrators.

FIG. 24 shows a cross sectional schematic view of another optical concentrator 214 in accordance with the present invention. Optical concentrator 214 illustrates cover 216 as attached to optical concentrator 214 by adhesive 218 and can be used with any of the optical concentrators described herein.

Solar concentrators, methods of making such solar concentrators, and methods of using such solar concentrators are described in assignee's copending nonprovisional patent application entitled PHOTOVOLTAIC RECEIVER FOR SOLAR CONCENTRATOR APPLICATIONS, to Harwood et al., filed Mar. 10, 2008, having U.S. Ser. No. 12/075,147, the entire disclosure of which is incorporated by reference herein for all purposes.

All cited patents and patent publications are incorporated herein by reference in their respective entireties for all purposes.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

What is claimed is:

1. An optical concentrator comprising:
one or more reflective elements; and
a shaping component having a shaping surface in contact with a surface of the one or more reflective elements;
wherein contact of the shaping component with the one or more reflective elements deforms the one or more reflective elements and at least partially defines a predetermined shape for the one or more reflective element.

2. The optical concentrator of claim 1, wherein the shaping component comprises a shaping rib.

3. The optical concentrator of claim 1, wherein the one or more reflective elements comprises a shell.

4. The optical concentrator of claim 3, comprising a plurality of shaping components spaced apart along the shell.

5. The optical concentrator of claim 3, wherein the shaping surface of the shaping component is in contact with an outside surface of the shell.

6. The optical concentrator of claim 3, wherein the shell comprises a trough.

7. The optical concentrator of claim 1, further comprising a shell distinct from the one or more reflective elements.

8. The optical concentrator of claim 7, wherein the shell comprises plural embossed regions.

9. The optical concentrator of claim 8, wherein the shaping component is positioned in a channel at least partially defined by adjacent embossed regions.

10. The optical concentrator of claim 7, wherein shell comprises at least one slot provided through a wall of the shell.

11. The optical concentrator of claim 10, wherein a portion of the shaping component extends through the at least one slot.

12. The optical concentrator of claim 1, further comprising a cover.

13. A method of shaping a reflective surface of an optical concentrator, the method comprising the steps of:
providing a reflective surface having a first shape;
providing a shaping component having a shaping surface; and
contacting a surface of the reflective surface with the shaping surface of the shaping component thereby deforming and repositioning the reflective surface to have a second shape different from the first shape.

14. The method of claim 13, comprising providing a plurality of shaping components.

15. The method of claim 13, wherein the reflective surface comprises a shell and comprising squeezing the shell with the shaping component to reposition the shell to have the second shape.

16. A hybrid optical concentrator comprising:
an aperture;
a shell comprising a reflective optical element that collects and focuses light onto a first target for a first portion of the aperture;
a refractive optical element that collects and focuses light onto a second target for a second portion of the aperture;
a plurality of shaping components, each having a shaping surface in contact with a surface of the reflective optical element;
wherein contact of the shaping surfaces of the plurality of shaping components with the shell deforms the shell and at least partially defines a predetermined shape for the reflective optical element of the shell.

17. The optical concentrator of claim 16, wherein one or more of the plurality of shaping components comprises a shaping rib.

18. The optical concentrator of claim 16, wherein one or more shaping surface of the plurality of shaping components is in contact with an outside surface of the shell.

19. The optical concentrator of claim 16, wherein one or more shaping surface of the plurality of shaping components is in contact with a surface of the reflective optical element.

20. The optical concentrator of claim 16, further comprising at least one cover.

21. A method of shaping assembling an optical concentrator, the method comprising the steps of:
providing one or more shaping ribs and one or more receivers;
positioning the one or more shaping ribs and the one or more receivers relative to each other;
attaching the one or more shaping ribs to a first portion of the one or more receivers to provide a shaping rib and receiver sub-assembly;
providing a shell;
positioning the shell relative to the shaping rib and receiver sub-assembly; and
attaching an inside surface of the shell to a second portion of the one or more receivers.
